(19) United States
(12) Patent Application Publication
(10) Pub. No.: US 2025/0378364 A1
(43) Pub. Date: Dec. 11, 2025

(54) ROBUST MULTI-HEAD REGRESSION METRICS FOR MACHINE LEARNING

(71) Applicant: INTUIT INC., Mountain View, CA (US)

(72) Inventor: Yaakov TAYEB, Tzur Hadassa (IL)

(21) Appl. No.: 18/734,855

(22) Filed: Jun. 5, 2024

(51) Int. Cl. G06N 20/00

(52) U.S. Cl. CPC G06N 20/00

(57) ABSTRACT

Aspects of the present disclosure provide techniques for multi-head machine learning model training. Embodiments include receiving training data comprising training inputs associated with ground truth labels corresponding to a plurality of variables, wherein the ground truth labels include a null value for a given variable of the plurality of variables. Embodiments include providing the training inputs to a machine learning model that is configured to generate predictions corresponding to the plurality of variables. Embodiments include receiving the predictions from the machine learning model in response to the training inputs. Embodiments include evaluating a loss function that compares the ground truth labels to the predictions and uses a masking value to disregard loss that corresponds to the given variable. Embodiments include updating one or more parameters of the machine learning model based on the evaluating of the loss function.

### INTRODUCTION

Aspects of the present disclosure relate to techniques for machine learning model training and analysis through robust multi-head regression metrics. In particular, embodiments involve a unique masking technique for accurately computing loss and accuracy based on ground truth labels that include values for fewer than all output variables.

### BACKGROUND

A machine learning model that generates multiple outputs when provided with input features may be referred to as a multi-head machine learning model, where each “head” corresponds to an output or prediction from the model. For example, a model may be trained to generate predictions for multiple output variables based on a single set of input features. Training a multi-head machine learning model generally involves the use of labeled training data in a supervised learning process. However, obtaining labeled training data that includes ground truth labels for all output variables of a multi-head machine learning model can be challenging. In many cases, a labeled training data instance includes ground truth labels for fewer than all output variables.

Existing techniques for training multi-head machine learning models do not account for the use of labeled training data that includes ground truth labels for fewer than all output variables. In current techniques, using such incompletely-labeled training data to train a multi-head machine learning model may result in inaccurate results. For example, a loss function that computes loss based on comparing output predictions from a multi-head machine learning model to ground truth labels without accounting for missing or null ground truth labels may produce inaccurate loss values, which may result in erroneous model training based on such inaccurate loss values. Furthermore, existing techniques for determining the accuracy of multi-head machine learning models without accounting for the use of labeled training (or testing) data that includes ground truth labels for fewer than all output variables may produce incorrect accuracy values.

What is needed are improved techniques for training and determining the accuracy of multi-head machine learning models using training data and/or test data that, at least in some instances, includes ground truth labels for fewer than all output variables.

### BRIEF SUMMARY

Certain embodiments provide a method for multi-head machine learning model training. The method generally includes: receiving training data comprising training inputs associated with ground truth labels corresponding to a plurality of variables, wherein the ground truth labels include a null value for a given variable of the plurality of variables; providing the training inputs to a machine learning model that is configured to generate predictions corresponding to the plurality of variables; receiving the predictions from the machine learning model in response to the training inputs; evaluating a loss function that compares the ground truth labels to the predictions and uses a masking value to disregard loss that corresponds to the given variable; and updating one or more parameters of the machine learning model based on the evaluating of the loss function.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is an illustration of an example of training a multi-head machine learning model, according to embodiments of the present disclosure.

FIG. 2 is an illustration of an example of determining the accuracy of a multi-head machine learning model, according to embodiments of the present disclosure.

FIG. 3 is an illustration of an example of using a multi-head machine-learning model that has been trained and/or analyzed using techniques described herein, according to embodiments of the present disclosure.

FIG. 4 depicts example operations related to multi-head machine learning model training, according to embodiments of the present disclosure.

FIG. 5 depicts an example processing system related to multi-head machine learning model training and/or analysis, according to embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for improved multi-head machine learning model training and/or analysis.

Training a multi-head machine learning model (e.g., a machine learning model that produces multiple outputs) generally involves the use of labeled training data. In many cases, it may be challenging to obtain labeled training data instances that include ground truth labels for all output variables of a multi-head machine learning model. Accordingly, techniques described herein involve utilizing a masking technique in order to make use of labeled training data instances that include ground truth labels for fewer than all output variables of a multi-head machine learning model for training and/or determining accuracy of the multi-head machine learning model.

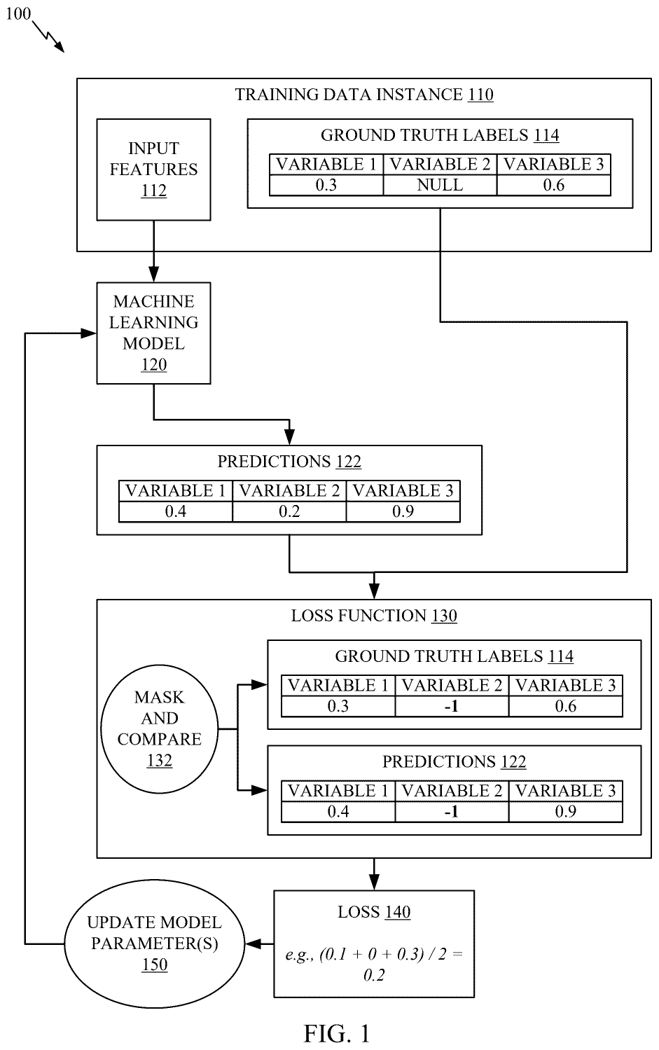

As described in more detail below with respect to FIG. 1, a loss function used in training a multi-head machine learning model may mask ground truth labels and model predictions corresponding to output variables for which ground truth data is not available in a given training data instance. It is important for the loss function to work when some heads are null, and this may be accomplished by including a mask layer within the function to omit from calculation any null values. For example, if a set of ground truth labels in a training data instance includes at least one null value corresponding to a given output variable (e.g., because ground truth was obtained for other output variables but not for the given output variable in this instance), that null ground truth label may be replaced in the training data set with a masking value such as a negative number. Similarly, the prediction produced by the model for the given variable in response to the training inputs in the training data instance may be replaced with the masking value. Use of the masking value may result in the loss function disregarding any loss resulting from the given output variable when computing loss during the training iteration.

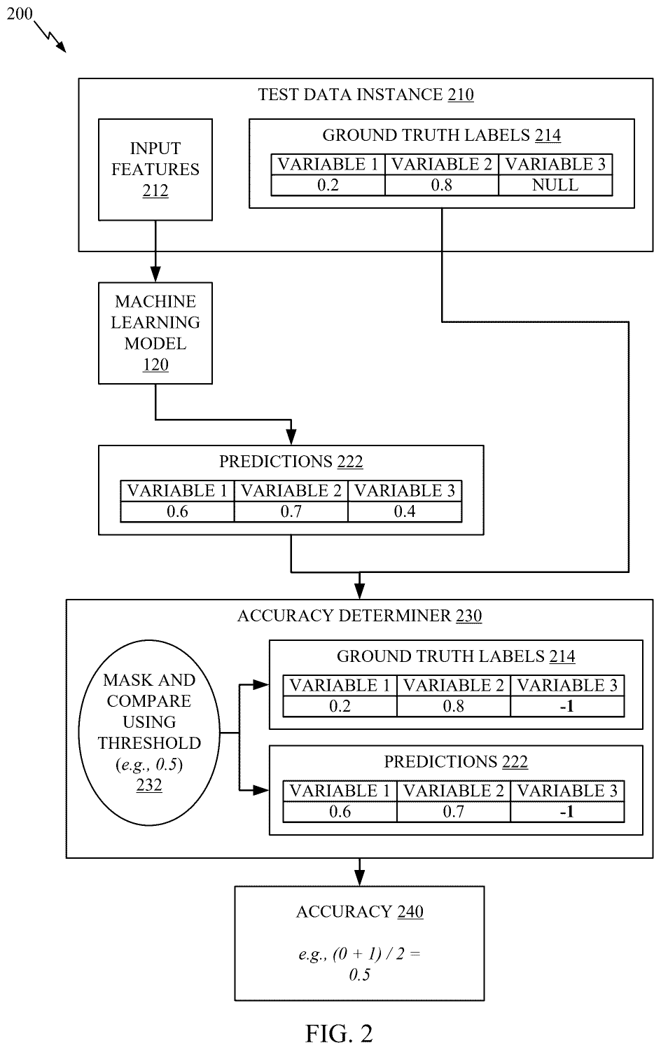

Furthermore, as described in more detail below with respect to FIG. 2, accuracy of a multi-head machine learning model may be determined through a process that involves masking ground truth labels and model predictions corresponding to output variables for which ground truth data is not available in a given training data instance. In some embodiments, accuracy determinations may be based on a threshold such that any output variables for which both the prediction and the ground truth label are on the same side of the threshold (e.g., while disregarding masked values) result in an increased accuracy value. Thus, techniques described herein allow for improved accuracy determinations for a multi-head machine learning model that account for incompletely labeled training data (through masking) and also focus on outcome-based accuracy (e.g., by determining whether predictions and corresponding ground truth labels fall on the same side of a threshold, such as a threshold above which a prediction is considered confident enough to perform one or more actions).

Techniques described herein improve the technical field of multi-head machine learning model training and analysis in a variety of ways. For instance, by utilizing a masking technique to compute loss and/or accuracy across multiple output variables in a manner that disregards loss or accuracy determinations attributable to null ground truth labels, techniques described herein allow for multi-head machine learning models to be trained and/or analyzed based on labeled training/test data that includes ground truth labels for fewer than all output variables without allowing the computed loss or accuracy to be skewed by null ground truth labels. Thus, embodiments of the present disclosure allow a multi-head machine learning model to be trained and analyzed for accuracy even using incompletely-labeled training/test data, thereby greatly expanding the universe of training/test data that can be used for such purposes as compared to existing training and analysis techniques and, by extension, improving loss and/or accuracy determinations as a result of such expansion.

Aspects of the present disclosure enable a computer to do what it could not previously do: namely, training and/or determining accuracy of a multi-head machine learning model using incompletely-labeled training and/or test data without the training or accuracy determinations being skewed towards incorrect results based on null ground truth labels. For example, loss functions described herein that replace predictions and corresponding ground truth labels with a masking value for output variables that include a null ground truth label enable loss to be calculated across multiple outputs variables without being affected by any null ground truth labels, and thereby allow a multi-head machine learning model to be accurately trained based on such training data using such a loss function. Furthermore, accuracy determination techniques described herein that utilizing masking techniques and threshold-based accuracy computations enable accuracy to be calculated across multiple outputs variables without being affected by any null ground truth labels and in a manner that focuses on outcome-based accuracy, and thereby allow accuracy of a multi-head machine learning model to be correctly determined using incomplete ground truth data across the multiple output variables and in a manner that reflects practical outcomes. No existing loss function accurately measures loss across multiple output variables of a multi-head machine learning model, particularly based on training data that includes null ground truth labels for one or more of the output variables, and aspects of the present disclosure enable such an accurate loss computation to be performed.

Additionally, techniques described herein avoid computing resource utilization that would otherwise occur in existing techniques as a result of faulty model training and/or accuracy determinations resulting from incompletely-labeled training and/or test data, such as in connection with deploying and/or using incorrectly-trained multi-head machine learning models and/or multi-head machine learning models that are incorrectly believed to be accurate. Furthermore, embodiments of the present disclosure avoid the costs and resources associated with obtaining exclusively completely-labeled training and test data across a plurality of output variables of a multi-head machine learning model.

### Example Training of a Multi-Head Machine Learning Model Using Incompletely-Labeled Training Data

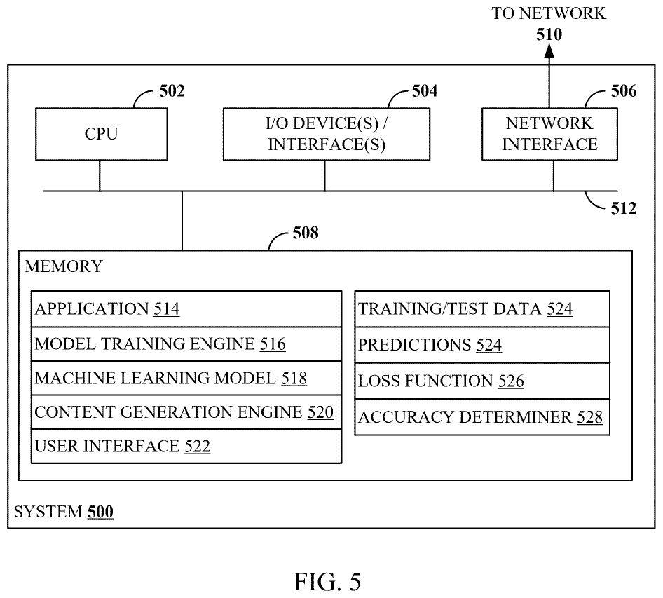

FIG. 1 is an illustration 100 of an example of training a multi-head machine learning model, according to embodiments of the present disclosure. For example, illustration 100 may represent a process performed by a model training component such as model training engine 516 of FIG. 5 (described below) to train a machine learning model 120.

A training data instance 110 generally represents one instance within a training data set that includes a plurality of such instances. Training data instance 110 includes input features 112, which generally include attributes that represent an entity (e.g., a user of a software application), associated with ground truth labels 114, which generally represent known values for multiple variables in association with the entity represented by input features 112. Training data, such as training data instance 110, may be generated based on historical data, manually provided and/or confirmed data, and/or the like. In one example, input features 112 represent a user, and include data about the user such as the user's application history, account type, length of use of the application, occupation, industry, interests, connections to other users, and/or the like. In such an example, ground truth labels 114 may include known values for the user for each of a plurality of variables, such as whether the user is likely to pay an invoice when an urgent tone is used in an invoicing message (e.g., variable 1), whether the user is likely to pay an invoice when a due date is included in the subject line of an invoicing message (e.g., variable 2), whether the user is likely to pay an invoice when line items are listed in the body of an invoicing message (e.g., variable 3), and/or the like. In an example, each of ground truth labels 114 is a value (e.g., a floating point value) between 0 and 1 that represents either a binary indication of whether a variable is true or false (e.g., 0 or 1) or a percentage of the time that a given variable is true (e.g., the user paid invoices when an urgent tone was used in invoicing messages in 30% of the cases in which such a tone is used). Notably, ground truth labels 114 may include one or more null values. For example, ground truth labels 114 do not include a ground truth label for “variable 2” (e.g., the label for variable 2 is null), such as because the user has not yet been provided with an invoicing message that includes a due date in the subject line (or a determination has not yet been made as to whether the user will pay the invoice based on such an invoicing message). It is noted that a null value generally refers to a missing, unpopulated, and/or otherwise null value. Ground truth labels 114 may, for example, be based on historical data indicating whether the user represented by input features 112 paid invoices when provided with different invoicing messages having different attributes.

Training data instance 110 is used to train machine learning model 120 through a supervised learning process. For example, machine learning model 120 may be a multi-head machine learning model that is configured to output predictions for each of a plurality of output variables (e.g., variable 1, variable 2, and variable 3) when provided with input features. Machine learning model 120 may, for example, be a neural network, a tree-based classifier, a Naïve Bayes classification model, a logistic regression model, and/or the like.

Neural networks, for example, generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network. In some cases, a neural network comprises one or more aggregation layers, such as a softmax layer. In one example, machine learning model 120 is a deep neural network, which generally has a larger number of hidden layers than a “shallow” neural network.

A tree-based model (e.g., a decision tree) makes a classification by dividing the inputs into smaller classifications (at nodes), which result in an ultimate classification at a leaf. Boosting, or gradient boosting, is a method for optimizing tree models. Boosting involves building a model of trees in a stage-wise fashion, optimizing an arbitrary differentiable loss function. In particular, boosting combines weak “learners” into a single strong learner in an iterative fashion. A weak learner generally refers to a classifier that chooses a threshold for one feature and splits the data on that threshold, is trained on that specific feature, and generally is only slightly correlated with the true classification (e.g., being at least more accurate than random guessing). A strong learner is a classifier that is arbitrarily well-correlated with the true classification, which may be achieved through a process that combines multiple weak learners in a manner that optimizes an arbitrary differentiable loss function. The process for generating a strong learner may involve a majority vote of weak learners. Examples of boosted tree models include XGBoost and LightGBM. A random forest extends the concept of a decision tree model, except the nodes included in any given decision tree within the forest are selected with some randomness. Thus, random forests may reduce bias and group outcomes based upon the most likely positive responses.

A Naïve Bayes classification model is based on the concept of dependent probability i.e., what is the chance of some outcome given some other outcome.

A logistic regression model takes some inputs and calculates the probability of some outcome, and the label may be applied based on a threshold for the probability of the outcome. For example, if the probability is >50% then the label is A, and if the probability is <=50%, then the label is B.

Supervised learning generally involves providing training inputs (e.g., input features 112) as inputs to machine learning model 120. Machine learning model 120 processes the training inputs and produces outputs (e.g., predictions 122 for a plurality of output variables) based on the training inputs. For example, an output layer of machine learning model 120 may be configured to output predictions 122 for each of a plurality of output variables. Predictions 122 may be normalized values (e.g., floating point values) between 0 and 1, such as being produced via a sigmoid function or other function in an output layer of machine learning model 120 that produces normalized values for each of the output variables. In an example, predictions 122 include predictions for the user for each of a plurality of variables, such as indicating a probability that the user represented by input features 112 will pay an invoice when an urgent tone is used in an invoicing message (e.g., variable 1), a probability that the user will pay an invoice when a due date is included in the subject line of an invoicing message (e.g., variable 2), a probability that the user will pay an invoice when line items are listed in the body of an invoicing message (e.g., variable 3), and/or the like. The outputs may be compared to the labels (e.g., ground truth labels 114) associated with the training inputs to determine the accuracy of the model, and parameters of machine learning model 120 may be iteratively adjusted until one or more conditions are met. For instance, the one or more conditions may relate to a loss function 130 for optimizing one or more variables (e.g., relating to model accuracy). In some embodiments, the conditions may relate to whether the predictions produced by the model based on the training inputs match the labels associated with the training inputs or whether a measure of error between training iterations is not decreasing or not decreasing more than a threshold amount. The conditions may also include whether a training iteration limit has been reached. Parameters of machine learning model 120 adjusted during training (e.g., at update model parameter(s) 150) may include, for example, hyperparameters, values related to numbers of iterations, weights, functions used by nodes to calculate scores, and the like. In some embodiments, validation and testing are also performed for machine learning model 120, such as based on validation data and test data, as is known in the art.

Loss function 130 may be a custom loss function, and may involve a mean squared error (MSE) computation or another suitable technique for computing loss based on predictions 122 and ground truth labels 114, such as separately computing differences between each prediction and its corresponding ground truth label rather than using a technique such as a softmax function that would create a single most probable solution and would therefore be unsuitable for training a multi-head machine learning model. According to certain embodiments, loss function 130 involves a masking technique that allows for determining loss 140 based on predictions 122 and ground truth labels 114 in an accurate manner despite ground truth labels 114 including one or more null labels. For example, at mask and compare 132, loss function 130 may replace the null value associated with variable 2 in ground truth labels 114 with a masking value (e.g., negative one, another negative number, or another distinct value) and may replace the prediction associated with variable 2 in predictions 122 with the same masking value (e.g., because there is a null ground truth label for that particular variable). Such masking may be performed via a masking layer within loss function 130. Furthermore, at mask and compare 132, loss function 130 may compare ground truth labels 114 with predictions 122 (e.g., after the masking) in order to compute loss 140. In an example, computing the loss involves determining differences between ground truth labels 114 and predictions 122 and dividing a sum of those differences (e.g., the sum of the absolute values of those differences) by the total number of non-masked ground truth labels (or, put another way, by the total number of variables for which a non-masked ground truth label is available). For example, the difference between the ground truth label for variable 1 (0.3) and the prediction for variable 1 (0.4) is 0.1, the difference between the ground truth label for variable 2 (which is set to −1 or another masking value) and the prediction for variable 2 (which is set to −1 or another masking value) is 0, and the difference between the ground truth label for variable 3 (0.6) and the prediction for variable 1 (0.9) is 0.3. Thus, the sum of the differences is 0.1+0+0.3. The total number of non-masked ground truth labels is 2. Accordingly, in such an example, loss 140 may be computed as (0.1+0+0.3)/2=0.2. It is noted that the example depicted and described is one way in which loss may be computed according to techniques described herein, and other ways of computing loss in such a manner as to disregard loss attributable to null ground truth labels through masking are possible. For example, −1 is included as an example of a masking value, and other masking values are possible. In one alternative implementation, the difference between a masked prediction and a masked ground truth label is not computed at all, and is simply omitted from the computation. For instance, all masked (e.g., in some embodiments, negative) values are excluded from the computation. In such an example, loss 140 may be computed as (0.1+0.3)/2=0.2. Generally, the use of masking in loss function 130 causes loss 140 to not be affected by null ground truth labels.

At update model parameter(s) 150, one or more parameters of machine learning model 120 may be updated based on loss 140. For example, a goal of the supervised learning process may be to minimize loss as computed using loss function 130 over a series of training iterations, with iterative updates being made to model parameters as each new loss value is computed.

Thus, techniques described herein enable machine learning model 120, which is a multi-head machine learning model, to be accurately trained based on training data instance 110 even though ground truth labels 114 in training data instance 110 include at least one null ground truth label (e.g., because ground truth for a particular variable is not available for a particular entity such as a particular user represented by input features 112).

### Example Accuracy Determination for Multi-Head Machine Learning Model

FIG. 2 is an illustration 200 of an example of determining the accuracy of a multi-head machine learning model, according to embodiments of the present disclosure. Illustration 200 includes machine learning model 120 of FIG. 1. For example, machine learning model 120 may be have been trained as described above with respect to FIG. 1.

A test data instance 210 generally represents one instance within a test data set (e.g., which may a subset of an overall labeled data set that includes a training data set and a test data set) that includes a plurality of such instances. For example, labeled data may be divided into training data that is used to train a model and test data that is used to test the trained model in order to determine accuracy. Test data instance 210 includes input features 212, which generally include attributes that represent an entity (e.g., a user of a software application), associated with ground truth labels 214, which generally represent known values for multiple variables in association with the entity represented by input features 212. Test data, such as test data instance 210, may be generated based on historical data, manually provided and/or confirmed data, and/or the like. In one example, input features 212 represent a user, and include data about the user such as the user's application history, account type, length of use of the application, occupation, industry, interests, connections to other users, and/or the like. In such an example, ground truth labels 214 may include known values for the user for each of a plurality of variables, such as whether the user is likely to pay an invoice when an urgent tone is used in an invoicing message (e.g., variable 1), whether the user is likely to pay an invoice when a due date is included in the subject line of an invoicing message (e.g., variable 2), whether the user is likely to pay an invoice when line items are listed in the body of an invoicing message (e.g., variable 3), and/or the like. In an example, each of ground truth labels 214 is a value (e.g., a floating point value) between 0 and 1 that represents either a binary indication of whether a variable is true or false (e.g., 0 or 1) or a percentage of the time that a given variable is true (e.g., the user paid invoices when an urgent tone was used in invoicing messages in 30% of the cases in which such a tone is used). Notably, ground truth labels 214 may include one or more missing or null values. For example, ground truth labels 214 do not include a ground truth label for “variable 3” (e.g., the label for variable 3 is null), such as because the user has not yet been provided with an invoicing message that includes line items listed in the body of the message (or a determination has not yet been made as to whether the user will pay the invoice based on such an invoicing message). Ground truth labels 214 may, for example, be based on historical data indicating whether the user represented by input features 212 paid invoices when provided with different invoicing messages having different attributes.

Test data instance 210 is used to determine accuracy of machine learning model 120. Such an accuracy determination process generally involves providing test inputs (e.g., input features 212) as inputs to machine learning model 120. Machine learning model 120 processes the test inputs and produces outputs (e.g., predictions 222 for a plurality of output variables) based on the test inputs. For example, an output layer of machine learning model 120 may be configured to output predictions 222 for each of a plurality of output variables. Predictions 222 may be normalized values (e.g., floating point values) between 0 and 1, such as being produced via a sigmoid function or other function in an output layer of machine learning model 120 that produces normalized values for each of the output variables. In an example, predictions 222 include predictions for the user for each of a plurality of variables, such as indicating a probability that the user represented by input features 212 will pay an invoice when an urgent tone is used in an invoicing message (e.g., variable 1), a probability that the user will pay an invoice when a due date is included in the subject line of an invoicing message (e.g., variable 2), a probability that the user will pay an invoice when line items are listed in the body of an invoicing message (e.g., variable 3), and/or the like. The outputs may be compared to the labels (e.g., ground truth labels 214) associated with the test inputs by an accuracy determiner 230 to determine the accuracy of the model.

Accuracy determiner 230 may use a similar masking technique to that described above with respect to the training of the machine learning model based on loss function 130 of FIG. 1. According to certain embodiments, accuracy determiner 230 involves a masking technique that allows for determining accuracy 240 based on predictions 222 and ground truth labels 214 in an accurate manner despite ground truth labels 214 including one or more null labels. For example, at mask and compare using threshold 232, accuracy determiner 230 may replace the null value associated with variable 3 in ground truth labels 214 with a masking value (e.g., negative one, another negative number, or another distinct value) and may replace the prediction associated with variable 3 in predictions 222 with the same masking value (e.g., because there is a null ground truth label for that particular variable). Furthermore, at mask and compare using threshold 232, accuracy determiner 230 may compare ground truth labels 214 with predictions 222 (e.g., after the masking) based on a particular threshold in order to compute accuracy 240. In an example, computing accuracy 240 involves determining whether each prediction falls on the same side of the threshold as its corresponding ground truth label. For instance, if the threshold is 0.5 (which may be a configurable value, and could be any value between 0 and 1), then determining accuracy 240 may involve determining whether each of ground truth labels 214 and its corresponding prediction 222 are on the same side of 0.5. Use of such a threshold produces an outcome-based accuracy determination that is not accessible in conventional regression metrics, such as conventional mean squared error computations. For example, in conventional mean squared error based accuracy computations, an accurate result is only determined if the prediction is exactly the same number (e.g., floating point value between 0 and 1) as the ground truth label. However, such conventional techniques would generally represent in a determination of inaccuracy for multi-head machine learning models that produce multiple floating point outputs, such as due to the likelihood of variability in a range of floating point values.

In the depicted example, the ground truth label 214 for variable 1 is 0.2 and the prediction 222 for variable 1 is 0.6. Thus, the prediction and ground truth label for variable 1 are on opposite sides of the threshold of 0.5. In such a case, a binary accuracy determination of 0 (e.g., meaning that the prediction is inaccurate) may be added to the accuracy count (e.g., because the prediction is confident enough to be treated as a confident positive, being above the threshold, while the ground truth label would be treated as a negative, being below the threshold). Furthermore, the ground truth label 214 for variable 2 is 0.8 and the prediction 222 for variable 2 is 0.7. Thus, the prediction and ground truth label for variable 2 are on the same side of the threshold of 0.5. In such a case, even though the prediction and the ground truth label do not exactly match, a binary accuracy determination of 1 (e.g., meaning that the prediction is accurate) may be added to the accuracy count (e.g., because both the prediction and the ground truth label are confident enough to be treated as a confident positive, being above the threshold). Variable 3 may be omitted from the accuracy calculation, as the ground truth label 214 and the prediction 222 for variable 3 have been replaced with a masking value.

In some embodiments, the sum of the binary accuracy determinations (0+1), such as omitting any masked values, may be divided by the total number of non-masked ground truth labels (or, put another way, by the total number of variables for which a non-masked ground truth label is available), which in this case is 2, to determine accuracy 240. In this example, the sum of the binary accuracy determinations is 0+1 and the total number of non-masked ground truth labels is 2. Accordingly, in such an example, accuracy 240 may be computed as (0+1)/2=0.5. It is noted that the example depicted and described is one way in which accuracy may be computed according to techniques described herein, and other ways of computing accuracy in such a manner as to disregard loss attributable to null ground truth labels through masking, and in such a manner as to focus on outcomes through the use of a threshold, are possible. Generally, the use of masking by accuracy determiner 230 causes accuracy 240 to not be affected by null ground truth labels. Furthermore, the use of a threshold (e.g., that may be configurable) causes accuracy 240 to reflect an outcome-based accuracy such that predictions that would likely be treated as a positive or negative are determined to be accurate based on whether the corresponding ground truth label would also be likely to be treated as a positive or negative.

Thus, techniques described herein enable machine learning model 120, which is a multi-head machine learning model, to be analyzed/tested for accuracy based on test data instance 210 even though ground truth labels 214 in test data instance 210 include at least one null ground truth label (e.g., because ground truth for a particular variable is not available for a particular entity such as a particular user represented by input features 212).

Accuracy 240 may be used for a variety of useful purposes. For example, accuracy 240 may be used to determine whether to deploy and/or use machine learning model 120, and/or whether to re-train machine learning model 120 (e.g., based on additional training data, such as if accuracy 240 is below a threshold). Furthermore, accuracy 240 may be provided (e.g., via a user interface) to a user of machine learning model 120, such as to indicate a level of confidence that the user may assign to predictions generated by machine learning model 120. In another example, accuracy 240 may be used to select between multiple machine learning models, such as choosing the machine learning model with the highest accuracy. In yet another example, accuracy 240 may be used to determine whether to take automated action based on a prediction generated by machine learning model 120, such as determining to perform an automatic action based on a prediction produced by machine learning model 120 if accuracy 240 is above a threshold or determining not to perform an automatic action (e.g., and instead to recommend the action to a user for manual review and approval) based on the prediction produced by machine learning model 120 if accuracy 240 is below the threshold. Generally, accuracy 240 allows machine learning model 120 to be better understood, such as enabling better decisions of how and/or if to use and/or re-train machine learning model 120.

### Example Use of a Trained Multi-Head Machine Learning Model

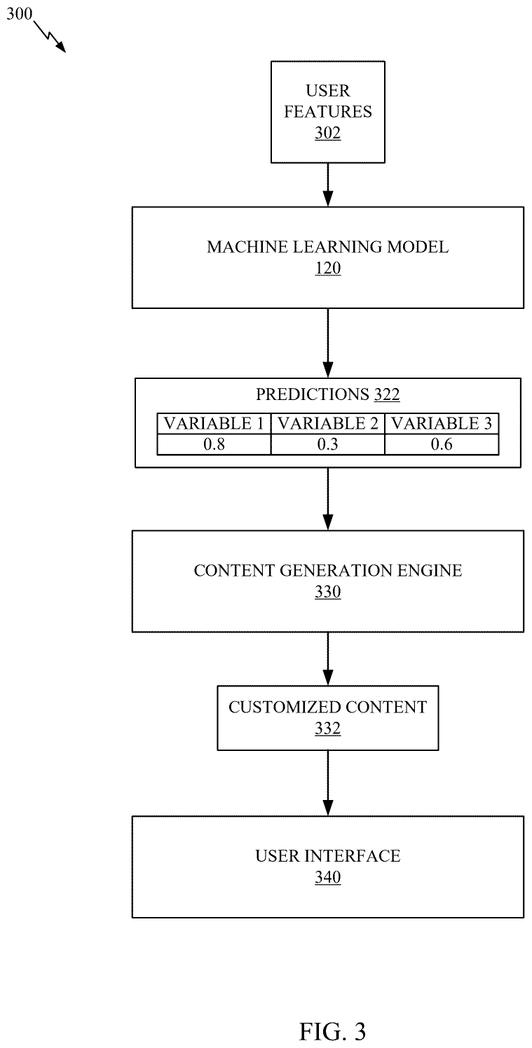

FIG. 3 is an illustration 300 of an example of using a multi-head machine-learning model that has been trained and/or analyzed using techniques described herein, according to embodiments of the present disclosure. Illustration 300 includes machine learning model 120 of FIG. 1 and/or FIG. 2. For example, machine learning model 120 may have been trained as described above with respect to FIG. 1 and/or an accuracy of machine learning model 120 may have been determined as described above with respect to FIG. 2. For example, a determination to deploy and/or use machine learning model 120 may be have been made based on an accuracy of machine learning model 120 exceeding a threshold.

A set of user features 302 generally represent a user of a software application, and include data about the user such as the user's application history (e.g., clickstream data), account type, length of use of the application, occupation, industry, interests, connections to other users, and/or the like. For example, user features 302 may represent a user that is different than one or more users represented by training data (e.g., training data instance 110 of FIG. 1) and/or test data (e.g., test data instance 210 of FIG. 2) that was used to train and/or determine accuracy of machine learning model 120.

User features 302 are provided as input features to machine learning model 120, which outputs predictions 322 in response to user features 302. Machine learning model 120 may be a multi-head machine learning model, and predictions 322 may represent predicted values for a plurality of output variables based on user features 302. In an example, predictions 322 include predictions for the user for each of a plurality of variables, such as indicating a probability that the user represented by user features 302 will pay an invoice when an urgent tone is used in an invoicing message (e.g., variable 1), a probability that the user will pay an invoice when a due date is included in the subject line of an invoicing message (e.g., variable 2), a probability that the user will pay an invoice when line items are listed in the body of an invoicing message (e.g., variable 3), and/or the like. It is noted that these particular variables are included as examples, and many other types of variables are possible.

Predictions 322 include a value of 0.8 for variable 1, a value of 0.3 for variable 2, and a value of 0.6 for variable 3. In some embodiments, predictions 322 may be used for a variety of practical purposes, such as to perform one or more actions based on predictions 322. In a particular example, predictions 322 are used by a content generation engine 220 to generate customized content 332 for the user represented by user features 302, such as to provide to the user via user interface 340. For instance, content generation engine 330 may use predictions to determine which of a plurality of different options to use for automatically generating content. In the depicted example, content generation engine 330 may determine based on predictions 322 to use variables 1 and 3, since the predictions for these variables are above a threshold (e.g., 0.5), and not to use variable 2, since the prediction for this variable is below the threshold.

In one embodiment, content generation engine 330 generates an invoicing message that is to be sent to the user along with an invoice, and one or more attributes of the invoicing message are dynamically determined based on predictions 322. For example, based on predictions 322, content generation engine 330 may generate an invoicing email (e.g., customized content 332) with an urgent tone and that lists line items in the body of the email, but that does not include a due date in the subject line. In a particular embodiment, predictions 322 are used to automatically generate customized content 332 based on accuracy of machine learning model 120 (e.g., determined as described above with respect to FIG. 2) exceeding a threshold.

In certain embodiments, content generation engine 330 may use one or more machine learning models to generate customized content 332. For example, content generation engine 330 may use a generative language processing machine learning model, such as a large language model (LLM) (e.g., a generative pre-trained transformer (GPT) model), to generate customized content 332. Content generation engine 330 may, for instance, automatically populate a natural language prompt to provide to such a generative model based on predictions 322, such as instructing the model to generate customized content 332 according to the attributes indicated by predictions 322 (e.g., an invoicing email with an urgent tone and that lists line items in the body of the email, but that does not include a due date in the subject line). Content generation engine 330 may also use other data related to the user and/or the content to be generated in order to populate such a prompt. The model may output customized content 332 in response to the prompt, and customized content 332 may be provided to the user (e.g., via a user interface 340). In one example, customized content 332 is an invoicing message that is transmitted (e.g., via email or otherwise) to the user along with an invoice that the user is expected to pay. In certain embodiments, predictions 322 and/or customized content 332 may be displayed to a user (e.g., a business that intends to send customized content 332 to the user represented by user features 302), such as in association with a determined accuracy of machine learning model 120, for review and approval prior to generating the content and/or sending the content to the user.

The user may provide feedback with respect to customized content 332, such as viewing, interacting with, responding to, and/or paying an invoice based on customized content 332, and the feedback (e.g., received via user interface 340 or otherwise) may be used as updated labeled training data and/or test data to re-train and/or determine accuracy of the machine learning model. For example, the user feedback may constitute ground truth for some or all output variables of machine learning model 120. In one example, if only some of the possible attributes were used to generate customized content 332, the user feedback may not constitute a ground truth label for one or more of the possible attributes (e.g., corresponding to the output variables of the model). For instance, if customized content 332 is an invoicing message with an urgent tone and that lists line items in the body of the email, but that does not include a due date in the subject line, and the user pays or does not pay the invoice based on such an invoicing message, this feedback may constitute ground truth labels for variables 1 and 2, but not for variable 3 (e.g., because it is unknown if including a due date in the subject line would have changed the outcome). Thus, techniques described above with respect to FIGS. 1 and 2 may be used to re-train and/or determine accuracy of machine learning model 120 based on such user feedback in such a manner that disregards the null ground truth label for variable 3 through masking.

It is noted that the particular use cases described herein, such as generating an invoicing email, are included as examples, and multi-head machine learning models trained and/or analyzed as described herein may be used for a variety of different purposes.

### Example Operations for Multi-Head Machine Learning Model Training

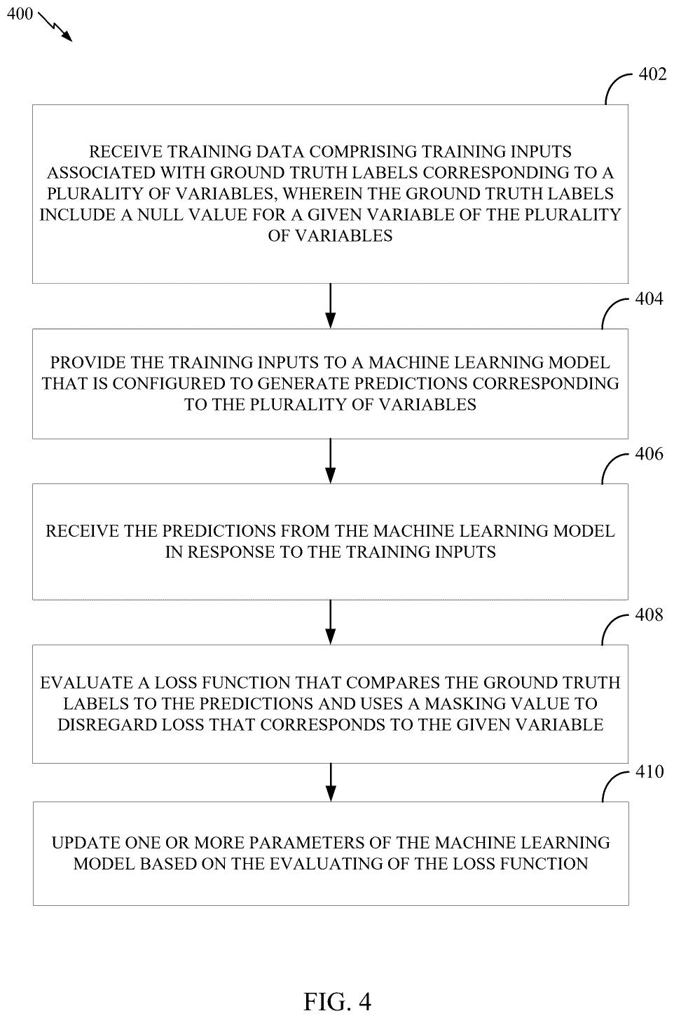

FIG. 4 depicts example operations 400 related to multi-head machine learning model training, according to embodiments of the present disclosure. For example, operations 400 may be performed by system 500 of FIG. 5 (described below) and/or one or more other computing components.

Operations 400 begin at step 402, with receiving training data comprising training inputs associated with ground truth labels corresponding to a plurality of variables, wherein the ground truth labels include a null value for a given variable of the plurality of variables.

Operations 400 continue at step 404, with providing the training inputs to a machine learning model that is configured to generate predictions corresponding to the plurality of variables.

Operations 400 continue at step 406, with receiving the predictions from the machine learning model in response to the training inputs.

In some embodiments, the receiving of the predictions from the machine learning model in response to the training inputs comprises receiving a plurality of normalized output values corresponding to the plurality of variables from an output layer of the machine learning model. For example, the normalized output values may be generated via a sigmoid function in the output layer of the machine learning model, and may represent probabilities associated with the plurality of variables. One example of such a sigmoid function is (1/(1+e^{∧}−x)).

Operations 400 continue at step 408, with evaluating a loss function that compares the ground truth labels to the predictions and uses a masking value to disregard loss that corresponds to the given variable.

In some embodiments, the evaluating of the loss function comprises replacing the null value in the ground truth labels with the masking value, replacing a prediction in the predictions that corresponds to the given variable with the masking value, and computing a loss value based on the replacing of the null value in the ground truth labels with the masking value and the replacing of the prediction in the predictions with the masking value.

In certain embodiments, the computing of the loss value comprises, after the replacing of the null value in the ground truth labels with the masking value and the replacing of the prediction in the predictions with the masking value, determining differences between the ground truth labels and the predictions and dividing a sum of the differences by a total number of ground truth labels in the ground truth labels that do not comprise the masking value.

In some embodiments, the masking value comprises a negative number.

Operations 400 continue at step 410, with updating one or more parameters of the machine learning model based on the evaluating of the loss function.

Some embodiments further comprise determining an accuracy of the machine learning model based on a number of instances in which both a prediction generated by the machine learning model and a corresponding ground truth label exceed a threshold.

In certain embodiments, the determining of the accuracy of the machine learning model is based on using the masking value to disregard an accuracy determination that corresponds to a null ground truth label.

Notably, method 400 is just one example with a selection of example steps, but additional methods with more, fewer, and/or different steps are possible based on the disclosure herein.

### Example Computing System

FIG. 5 illustrates an example system 500 with which embodiments of the present disclosure may be implemented. For example, system 500 may be configured to perform one or more of the techniques described above with respect to FIGS. 1-3 and/or operations 400 of FIG. 4.

System 500 includes a central processing unit (CPU) 502, one or more I/O device interfaces 504 that may allow for the connection of various I/O devices 514 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes an application 514, which may be a software application that provides various types of functionality. In one example, application 514 enables a user to request generation of customized content for another user, such as using a machine learning model trained and/or analyzed using techniques described herein, and/or to access and/or provide feedback with respect to such content. Memory 508 further includes a model training engine 516, which may be configured to perform model training techniques described herein, such as the techniques for training a multi-head machine learning model described above with respect to FIG. 1. Memory 508 further includes a machine learning model 518, which may be representative of machine learning model 120 of FIGS. 1, 2, and/or 3. Memory 508 further includes content generation engine 520 and user interface 522, which may be representative of content generation engine 330 and user interface 340 of FIG. 3. Memory 508 further includes training/test data 524, which may include training data instance 110 of FIG. 1 and/or test data instance 210 of FIG. 2. Memory 508 further includes predictions 524, which may include predictions 122 of FIG. 1, predictions 222 of FIG. 2, and/or predictions 322 of FIG. 3. Memory 508 further includes loss function 526, which may be representative of loss function 130 of FIG. 1. Memory 508 further includes accuracy determiner 528, which may be representative of accuracy determiner 230 of FIG. 2.

It is noted that functionality described herein may be implemented via more or fewer components, on the same device and/or separate devices, than those depicted in FIG. 6.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for multi-head machine learning model training, comprising:
receiving training data comprising training inputs associated with ground truth labels corresponding to a plurality of variables, wherein the ground truth labels include a null value for a given variable of the plurality of variables;
providing the training inputs to a machine learning model that is configured to generate predictions corresponding to the plurality of variables;
receiving the predictions from the machine learning model in response to the training inputs;
evaluating a loss function that compares the ground truth labels to the predictions and uses a masking value to disregard loss that corresponds to the given variable; and
updating one or more parameters of the machine learning model based on the evaluating of the loss function.

2. The method of claim 1, wherein the evaluating of the loss function comprises:
replacing the null value in the ground truth labels with the masking value;
replacing a prediction in the predictions that corresponds to the given variable with the masking value; and
computing a loss value based on the replacing of the null value in the ground truth labels with the masking value and the replacing of the prediction in the predictions with the masking value.

3. The method of claim 2, wherein the computing of the loss value comprises, after the replacing of the null value in the ground truth labels with the masking value and the replacing of the prediction in the predictions with the masking value, determining differences between the ground truth labels and the predictions and dividing a sum of the differences by a total number of ground truth labels in the ground truth labels that do not comprise the masking value.

4. The method of claim 3, wherein the masking value comprises a negative number.

5. The method of claim 1, further comprising determining an accuracy of the machine learning model based on a number of instances in which both a prediction generated by the machine learning model and a corresponding ground truth label exceed a threshold.

6. The method of claim 5, wherein the determining of the accuracy of the machine learning model is based on using the masking value to disregard an accuracy determination that corresponds to a null ground truth label.

7. The method of claim 1, wherein the receiving of the predictions from the machine learning model in response to the training inputs comprises receiving a plurality of normalized output values corresponding to the plurality of variables from an output layer of the machine learning model.

8. A system for multi-head machine learning model training, comprising:
one or more processors; and
a memory comprising instructions that, when executed by the one or more processors, cause the system to:
receive training data comprising training inputs associated with ground truth labels corresponding to a plurality of variables, wherein the ground truth labels include a null value for a given variable of the plurality of variables;
provide the training inputs to a machine learning model that is configured to generate predictions corresponding to the plurality of variables;
receive the predictions from the machine learning model in response to the training inputs;
evaluate a loss function that compares the ground truth labels to the predictions and uses a masking value to disregard loss that corresponds to the given variable; and
update one or more parameters of the machine learning model based on the evaluating of the loss function.

9. The system of claim 8, wherein the evaluating of the loss function comprises:
replacing the null value in the ground truth labels with the masking value;
replacing a prediction in the predictions that corresponds to the given variable with the masking value; and
computing a loss value based on the replacing of the null value in the ground truth labels with the masking value and the replacing of the prediction in the predictions with the masking value.

10. The system of claim 9, wherein the computing of the loss value comprises, after the replacing of the null value in the ground truth labels with the masking value and the replacing of the prediction in the predictions with the masking value, determining differences between the ground truth labels and the predictions and dividing a sum of the differences by a total number of ground truth labels in the ground truth labels that do not comprise the masking value.

11. The system of claim 10, wherein the masking value comprises a negative number.

12. The system of claim 8, wherein the instructions, when executed by the one or more processors, further cause the system to determine an accuracy of the machine learning model based on a number of instances in which both a prediction generated by the machine learning model and a corresponding ground truth label exceed a threshold.

13. The system of claim 12, wherein the determining of the accuracy of the machine learning model is based on using the masking value to disregard an accuracy determination that corresponds to a null ground truth label.

14. The system of claim 8, wherein the receiving of the predictions from the machine learning model in response to the training inputs comprises receiving a plurality of normalized output values corresponding to the plurality of variables from an output layer of the machine learning model.

15. A non-transitory computer readable medium comprising instructions that, when executed by one or more processors of a computing system, cause the computing system to:
receive training data comprising training inputs associated with ground truth labels corresponding to a plurality of variables, wherein the ground truth labels include a null value for a given variable of the plurality of variables;
provide the training inputs to a machine learning model that is configured to generate predictions corresponding to the plurality of variables;
receive the predictions from the machine learning model in response to the training inputs;
evaluate a loss function that compares the ground truth labels to the predictions and uses a masking value to disregard loss that corresponds to the given variable; and
update one or more parameters of the machine learning model based on the evaluating of the loss function.

16. The non-transitory computer readable medium of claim 15, wherein the evaluating of the loss function comprises:
replacing the null value in the ground truth labels with the masking value;
replacing a prediction in the predictions that corresponds to the given variable with the masking value; and
computing a loss value based on the replacing of the null value in the ground truth labels with the masking value and the replacing of the prediction in the predictions with the masking value.

17. The non-transitory computer readable medium of claim 16, wherein the computing of the loss value comprises, after the replacing of the null value in the ground truth labels with the masking value and the replacing of the prediction in the predictions with the masking value, determining differences between the ground truth labels and the predictions and dividing a sum of the differences by a total number of ground truth labels in the ground truth labels that do not comprise the masking value.

18. The non-transitory computer readable medium of claim 17, wherein the masking value comprises a negative number.

19. The non-transitory computer readable medium of claim 15, wherein the instructions, when executed by the one or more processors, further cause the computing system to determine an accuracy of the machine learning model based on a number of instances in which both a prediction generated by the machine learning model and a corresponding ground truth label exceed a threshold.

20. The non-transitory computer readable medium of claim 19, wherein the determining of the accuracy of the machine learning model is based on using the masking value to disregard an accuracy determination that corresponds to a null ground truth label.
